(19) United States
(12) Patent Application Publication
(10) Pub. No.: US 2016/0341173 A1
(43) Pub. Date: Nov. 24, 2016

(54) METHOD FOR INSTALLING A SO-CALLED "MARINE" PUMPED-STORAGE HYDROELECTRIC POWER PLANT AND CORRESPONDING PLANT

(71) Applicant: STX FRANCE S.A., Saint Nazaire (FR)

(72) Inventor: Eric COULON, Saint. Michel, Chef Chef (FR)

(73) Assignee: STX FRANCE S.A., Saint Nazaire (FR)

(21) Appl. No.: 15/111,018

(22) PCT Filed: Jan. 15, 2015
(86) PCT No.: PCT/EP2015/050628

§ 371 Date: Jul. 12, 2016

(30) Foreign Application Priority Data
Jan. 17, 2014 (FR) 1450390

(51) Int. Cl. F03B 13/06; F04D 13/16; F03B 3/10

(52) U.S. Cl. CPC F03B 13/06; F03B 3/10; F04D 13/16; F05B 2240/97; F05B 2230/60

(57) ABSTRACT

The present invention relates to a method for installing a pumped-storage hydroelectric power station, referred to as “marine PSH station”, which includes a dam located at a higher altitude than sea level, a hydroelectric plant configured to operate as a pump-motor assembly for pumping seawater towards said dam, or as a turbine-alternator assembly for producing electricity by releasing water from the dam into the sea via at least one pipe connecting said dam to said hydroelectric plant; characterized in that: the hydroelectric plant used is presented in the form of at least one coffer dam at least the bottom portion of which is sealed; said coffer dam is transported until the base of said dam (RE); said coffer dam is immobilized in the sea; and said coffer dam is connected to said pipe.

The present invention relates to a method for installing a Pumped-Storage Hydroelectric power plant, called a “marine PSH plant.”

It also relates to such a transfer plant.

The present energy world is undergoing profound evolution, with a strong increase in consumption in countries such as China, India or southeast Asia. This increase in consumption is also felt, more moderately, in the western countries of western Europe and North America.

Added to this increase is an upheaval in the field of energy production with the arrival of the growth peak in energies derived from fossil fuels.

Finally, the events which occurred in 2011 in Fukushima have a direct influence on energy policies in a great number of countries: reduction in nuclear production (Switzerland, Germany, Japan) and development of intermittent energy.

The increase in the variation of demand and the development of intermittent renewable energies such as wind or photovoltaic require new solutions allowing better management of the balance between production and consumption.

Besides prediction techniques for intermittent energy and better management of the grid, of consumption and of production, solutions for storing energy can contribute to the balance of the system.

At the present time, plantary storage solutions of the battery type are only slightly developed, due to the size required for the installations. Moreover, storage by compressed air has mediocre efficiency.

On the other hand, hydraulic storage (pumps-turbines), which represents at present the great majority of mass storage in the world, seems to have plenty of room to respond to new energy challenges.

The operating principle of a PSH plant (Pumped-Storage Hydroelectric power plant) comprises two phases, one of pumping water from a lower reservoir to an upper reservoir (that is one located at a higher altitude) when it is desired to store energy, and the other of running the water from the upper reservoir through turbines into the lower reservoir when it is desired to produce electricity.

Besides an upper reservoir and a lower reservoir, a PSH plant consists of a hydroelectric plant capable of operating as a pump/motor unit to pump water from said lower reservoir to said upper reservoir or as a turbine/alternator unit to produce electricity by releasing water from said upper reservoir to said lower reservoir. It also consists of a so-called “forced” tube connecting said upper reservoir to said pump-turbine of the hydroelectric plant and of a so-called “downstream” tube connecting the lower reservoir to said pump-turbine of the hydroelectric plant.

The case of a “marine” PSH plant is similar to that of a “conventional” PSH plant, called “land-based,” except that the lower reservoir is replaced by the sea or ocean.

Worldwide, 99% of plantary energy storage capacity is provided by PSH plant (source: Rapport sur l'industrie des énergies decarbonnées—2010 [Report on de-carbonated energy industries—2010]).

In Europe, 40 GW of installed PSH plant capacity is currently enumerated (representing 30% of worldwide PSH plant capacity). Four GW of capacity are currently under construction and an increase in European capacity of 35% is expected between 2010 and 2020. The PSH plant market is thus undergoing a considerable expansion which it had not experienced since the 80s, connected in particular with the development and the optimization of nuclear capacity.

Outside of Europe, it is in Asia that the market is undergoing its greatest expansion, because the installed capacity will have doubled between 2005 (25 GW) and 2020 (50 GW). Projections make it possible to evaluate the worldwide need for mass storage between 500 and 1,000 GW in 2030/2040, from development in the penetration of intermittent renewable energies, of which a large portion will continue to be provided by PSH plants, the rest being provided by the technique called “CAES” for compressed air energy storage, which is emerging.

The development of land-based PSH plants in Europe will be constrained, in the coming years, by the fact that the best sites have already been equipped, and by the environmental context.

Moreover, the hydraulic circuits of the land-based PSH plants (that is the length of the tubes between reservoirs) is relatively long and does not make possible the attainment of short response times (less than 10 s). Marine PSH plants dispense with this problem and make it possible to minimize the cost and environmental impacts, while offering the possibility of installations near offshore wind fields.

The marine PSH plant is consequently a technique which would make it possible to supplement land-based PSH plants.

However, the following observation is made:

The idea that arises naturally is to create a marine PSH plant on the basis of an industrial scheme identical to that for achieving a land-based PSH plant, and therefore in particular with the following constraints:
the hydro-electric plant is installed partially underground, in a cavern or a well;
the main equipment (pumps, turbines, alternators, transformers . . . ) are brought to the site by way of land, which requires considerable transportation means;
the costs and delays depend heavily on the geology and typography of the site, leading to considerable financial risk for the project, which investors do not like.

From document EP1930597, an Archimedes screw machine is known which makes it possible to pump a liquid from a lower level to an upper level, or to generate energy when the liquid flows downward.

This machine includes a base which is positioned at the bottom in the lowest reservoir. The base comprises a tube within which is housed an Archimedes screw. At the top end of the axis of rotation of this screw is mounted an electric motor. A pipe causes the upper end of the tube to communicate with the upper water level.

Such a device does not constitute a PSH plant within the meaning of the invention.

The present invention has precisely the goal of correcting the disadvantages listed and detailed above.

Thus according to a first aspect, it relates to an installation method of a plant for transferring energy by pumping, so-called a “marine PSH plant,” which includes:
a water reservoir located at altitude relative to sea level;
a hydroelectric plant configured to operate as a pump-motor unit to pump water from the sea to said water reservoir, or as a turbine-alternator unit to produce electricity by releasing the water, from the reservoir to the sea, via at least one tube connecting said water reservoir to said hydroelectric plant, characterized by the fact that:
a hydroelectric plant is used which has the shape of at least one caisson of which at least the lower portion is watertight;
said caisson is transported to the “root” of said water reservoir;
said caisson is immobilized in the sea;
and it is connected to said tube.

According to other non-limiting and advantageous features of this method:
said caisson is immobilized in the sea while it is partially submerged;
transportation of said caisson is accomplished by launching it on the surface of the water and towing using at least one motor craft;
transportation of said caisson is accomplished by placing it on a barge;
a caisson is used from which at least one pipe protrudes for connection to said tube;
prior to immobilization of said caisson, a base is installed embedded in the sea bottom, onto which said caisson is subsequently brought;
a means for protecting the caisson is subsequently placed, such as a jetty, a floating breakwater, or a protection system integrated with the caisson.

Another aspect of the invention relates to a plant for transferring energy by pumping, so-called a “marine PSH plant,” which includes:
a water reservoir located at altitude relative to sea level; and
a hydroelectric plant configured to operate as a pump-motor unit for pumping water from the sea to said water reservoir, or as a turbine-alternator unit to produce electricity by releasing the water from the reservoir toward the sea, via at least one tube connecting said water reservoir to the sea,
characterized by the fact that said hydroelectric plant has the shape of at least one caisson which is at least partially watertight, immobilized in the sea, at the “root” of said water reservoir.

Advantageously, this plant comprises several caissons lashed to one another.

Other features and advantages of the invention will appear upon reading the detailed description that follows. It will be made with reference to the appended drawings wherein:

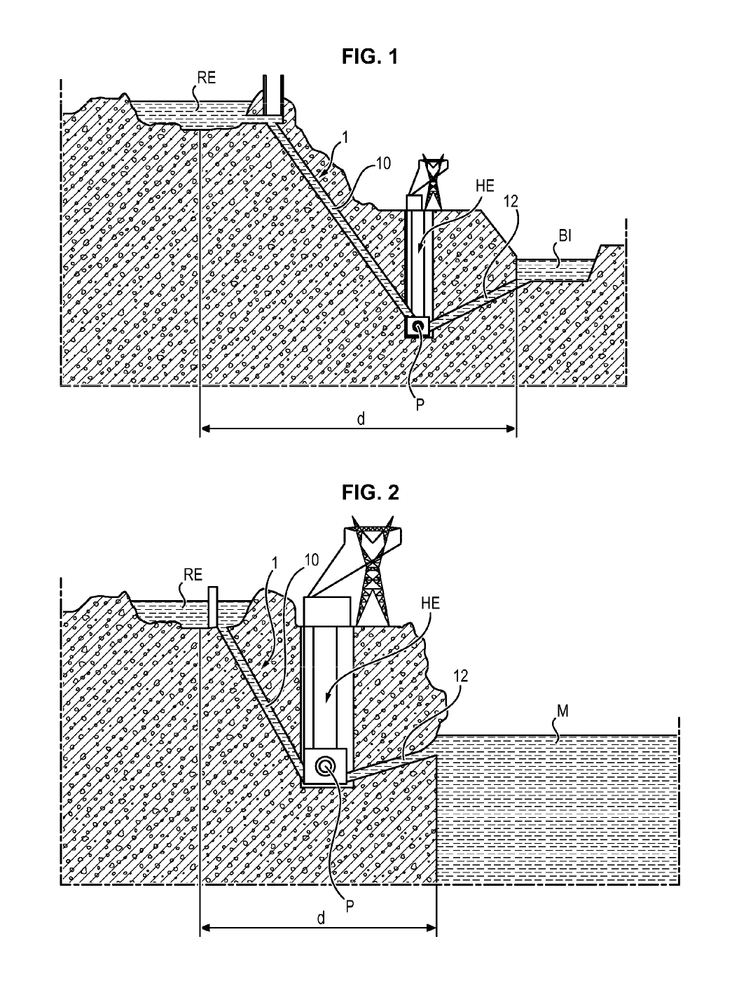

FIGS. 1 and 2 are simplified section views, in a vertical and longitudinal plane, of two embodiments of a pumped-storage hydroelectric power plant according to the prior art;

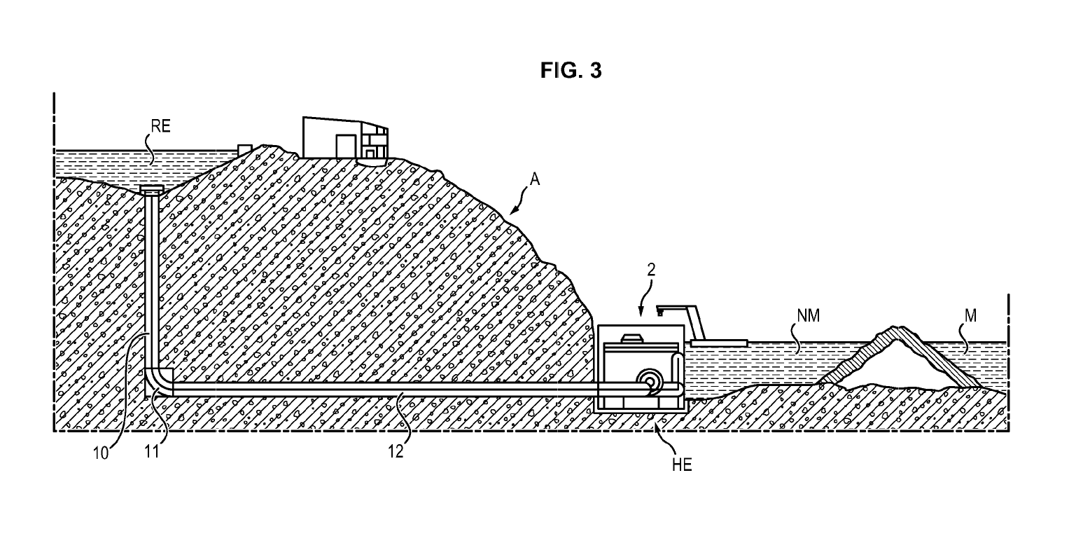

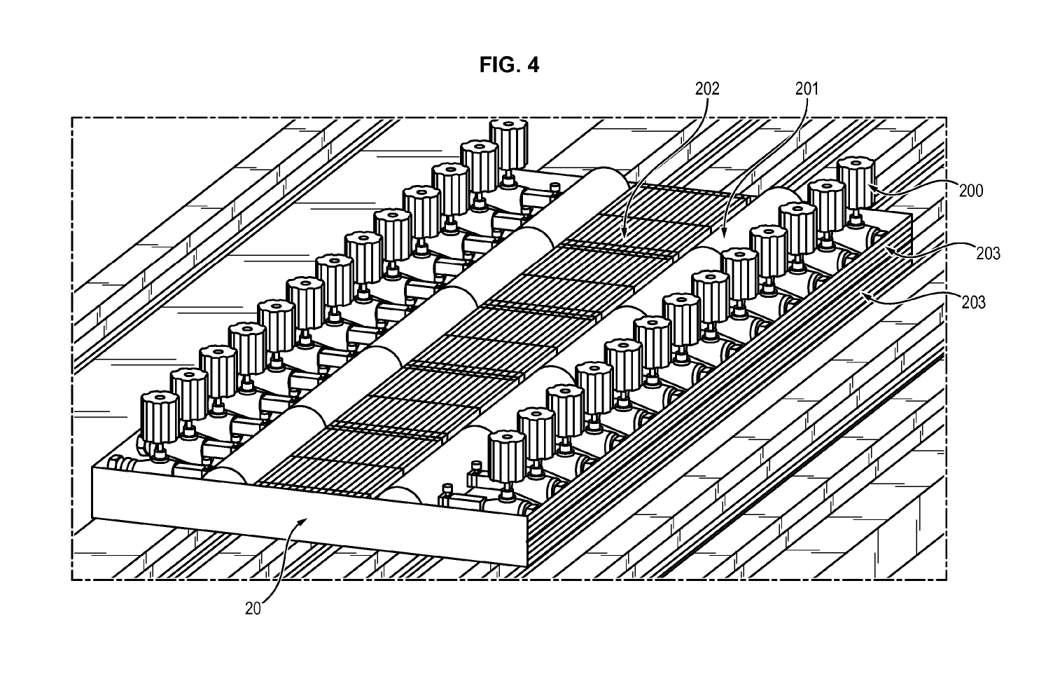

FIG. 3 is a simplified section view in a vertical and longitudinal plane of an embodiment of a plant for transferring energy by pumping, so-called a “marine PSH plant,” conforming to the invention;
FIG. 4 is a perspective view of a lower element of a caisson forming a hydroelectric plant, used within the scope of the present invention;

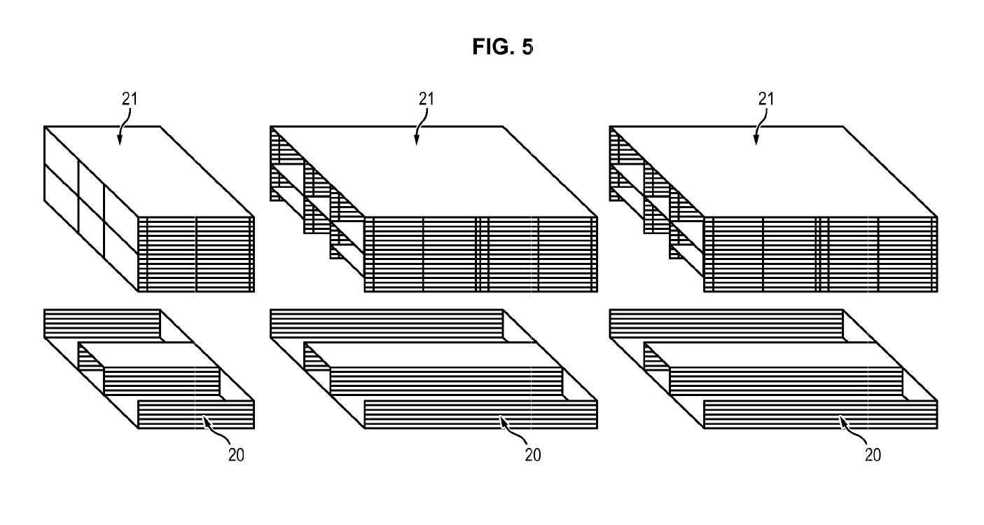

FIG. 5 is also a perspective view showing several lower elements of a caisson, of different sizes, as well as the upper elements designed to cover them;

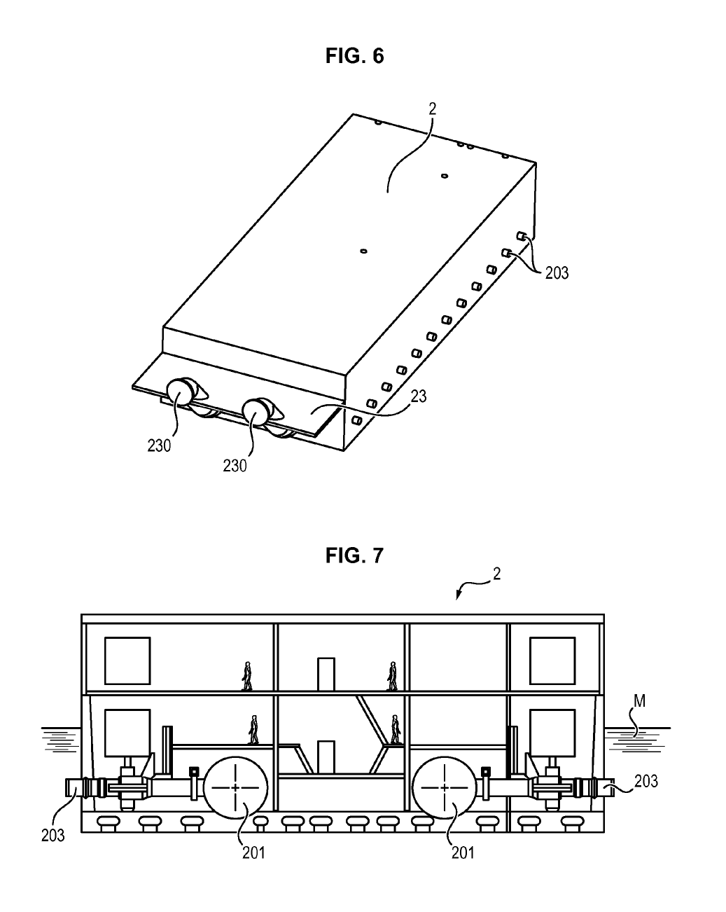

FIG. 6 is a perspective view of a caisson used within the scope of the invention and obtained by combining one or more upper and lower elements such as those of the preceding figure;

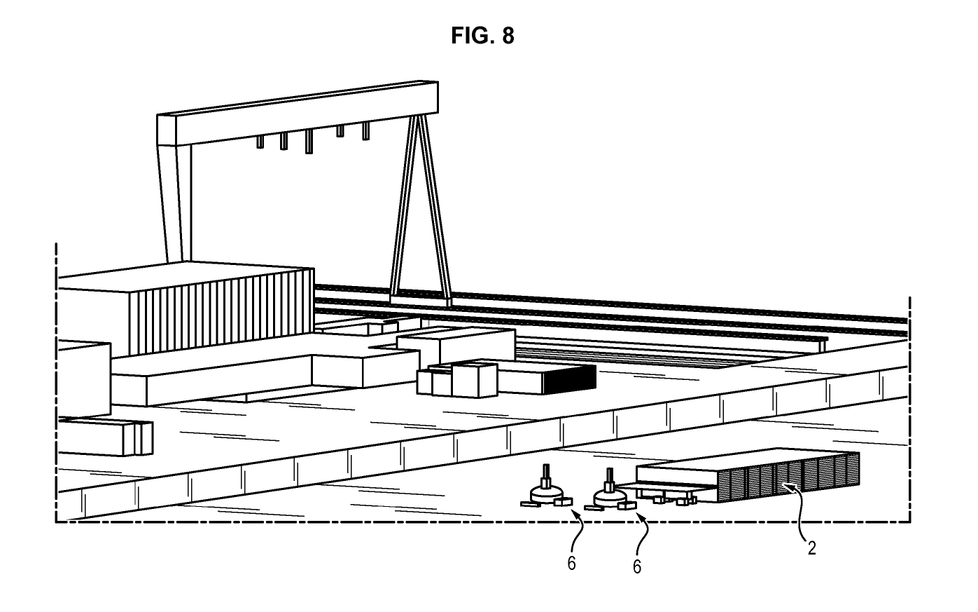

FIG. 7 is a section view, along a vertical and transverse plane, of a caisson;

FIG. 8 is a perspective view of a caisson placed in the water and towed by two motor crafts;

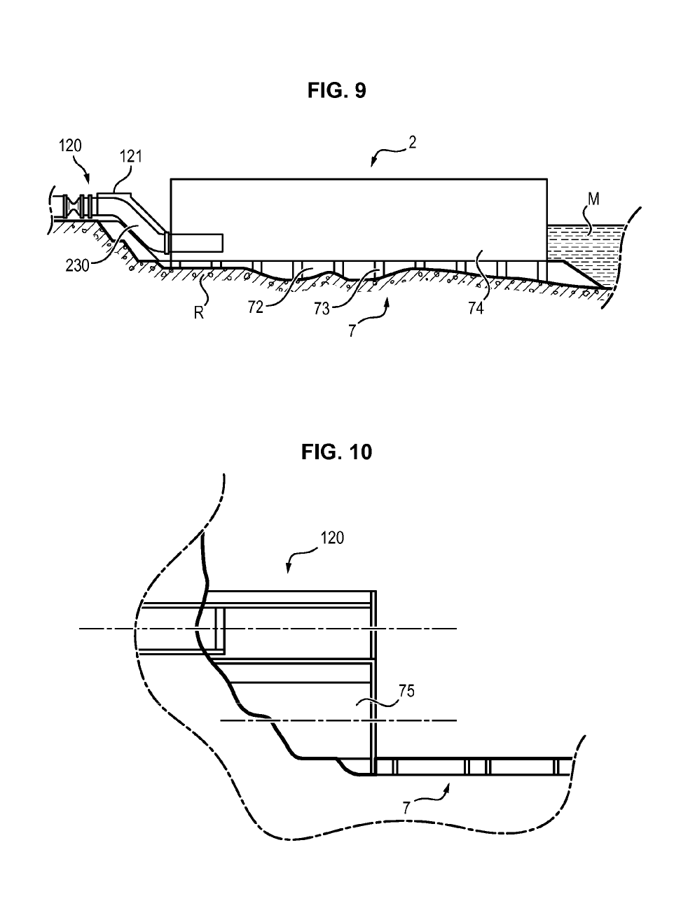

FIG. 9 is a section view, along a vertical and longitudinal plane, of a base located at seaside, “at the root” of the water reservoir and designed to receive a caisson such as that shown in FIG. 8;

FIG. 10 is a section view, also along a vertical and longitudinal plane, of the “distal” end of the tube of the plant, that is that which is designed to be connected to the caisson;

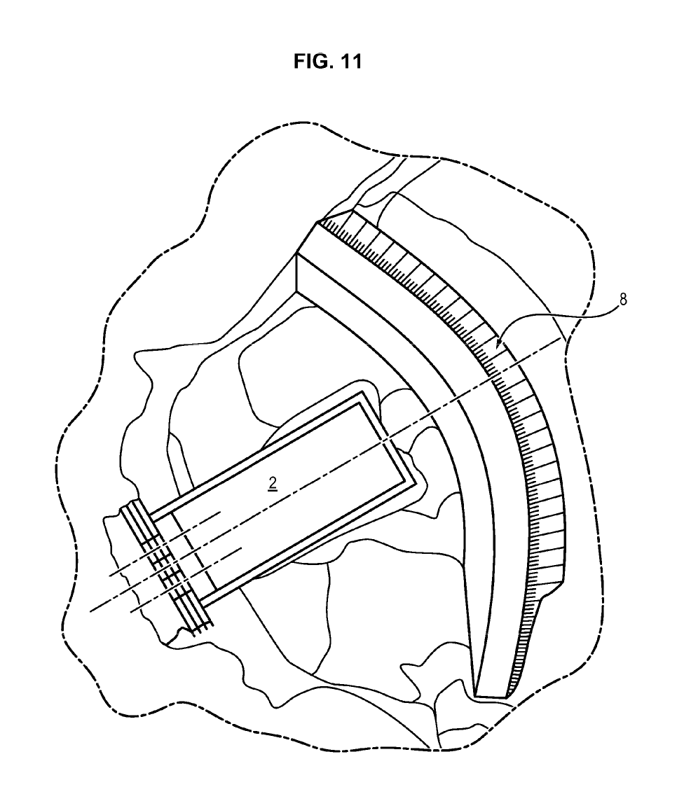

finally, FIG. 11 is a view from above a caisson and a protective jetty for it.

In all of the description that follows, when the expression “plant for transferring energy by pumping,” PSH plant for short, is used, it will be understood, unless otherwise stated, that it is a marine PSH plant that is mentioned.

Moreover, the terminologies “water reservoir” and “upper reservoir” will be used interchangeably.

FIGS. 1 and 2 show respectively a land-based PSH plant and a marine PSH plant according to the prior art.

Thus, as shown in FIGS. 1 and 2, the pump-turbines P of the hydroelectric plants HE are installed underground, in a cavern or a well, connected to the upper reservoir RE by a forced tube 10 and to the lower reservoir BI or to the sea M by a downstream tube 12. Electrical plants, electrical panels and transformers, are installed in the “electrical plants” buildings located above the associated pump-turbines.

The presence of a well 3 is observed, equipped with an elevator, which allows the operators in particular to gain access to the pump-turbine or to enter into the tube so as to check their condition and to proceed with their maintenance, if needed.

By way of indication, the distance d separating the upper water reservoir RE and the lower reservoir BI is on the order of a few thousand meters. This distance, within the scope of a marine PSH plant, is on the order of a few hundred meters.

As specified above, the appended FIG. 3 shows a marine PSH plant conforming to the invention.

Thus, as illustrated in FIG. 3, the plant is installed at seaside, along a coast A forming a cliff.

In known fashion, a water reservoir RE, which can be natural or artificial, is present on the upper portion of the coast. It is therefore situated at altitude with respect to sea M level NM. By way of indication, the corresponding difference in elevation can be comprised between 50 and 300 meters.

A tube 1 connects the bottom of the reservoir RE with a caisson 2.

This tube, which is dimensioned according to the level of energy that it is desired to produce, comprises a vertical “branch” 10 of which the upper end leads into the reservoir RE and a horizontal “branch” 12 leading into the caisson.

This branch 12, so-called “downstream,” can have another disposition. It can for example be sloped.

The aforementioned branches are naturally connected by an intermediate, curved portion 11.

The techniques for excavating and laying out this tube are naturally known to the person skilled in the art and will therefore not be described further.

A hydroelectric plant HE is also visible in FIG. 3 which is positioned in the sea, “at the root” of the reservoir RE, which means that it is directly connected to the free (or distal) end of the branch 12 of the tube 1. This plant takes the form of the aforementioned caisson 2.

The structure of the plant and its mode of fabrication will be discussed in greater detail later in the description.

As is particularly visible in FIGS. 4 to 7, the hydroelectric plant HE in particular likely to be used in the scope of the present invention takes the form of a caisson 2, preferably metallic, which is sealed over at least its lower portion. This caisson is preferably made by assembling blocks of prefabricated structure. This makes possible in particular simple and rapid installation of large equipment (energy system and auxiliary systems) composing the hydroelectric plant HE, which is organized as the blocks are assembled as shown in FIG. 5.

In this figure and in FIG. 4 also, the caisson 2 includes at least one lower element 20 (here three elements are shown) which are included in a parallelepiped rectangle. It includes a bottom, and vertical longitudinal and transverse walls. It is therefore open at the top.

This lower element comprises a portion of the usual equipment of a hydroelectric plant, and particularly the pumps-turbines 200, electrical panels, transformers, ventilation systems, freshwater production systems, drainage systems, etc. The element 201 visible in FIG. 4 is a segment of a tube inside the caisson and the element 230 a segment of a tube outside the caisson for connection to the tube 1. Piping 203 makes it possible to pump sea water to the tube 1 or to release water from the tube 1 to the sea M when the hydroelectric plant HE operates respectively as a pump-motor unit or as a turbine-alternator unit.

Naturally, as shown in FIG. 5, each lower element 20 is designed to accommodate an upper element 21 which covers it, the assembly then forming a caisson.

The connections between the elements 20 and 21 are provided by any known means that make it possible to ensure the sealing of the caisson 2, particularly by welding.

A caisson 2 is visible in FIG. 6 in perspective. It will be noted that along one of its transverse faces extends a plate 23, parallel to its upper and lower faces. This plate serves as an access platform to the caisson 2 for operators, or for loading/unloading equipment. This plate also serves as a support means for a pair of connecting pipes 230 whose function will be explained subsequently.

It was said earlier that at least the lower portion of the caisson is sealed (watertight). In fact, as will be seen below, this lower portion is designed to extend below the surface NM of the sea M. However, and preferably, the totality of the surface of the caisson is designed to be sealed (watertight).

One of the PSH plants in the method according to the invention resides in the fact that the caisson 2 is brought up to the “root” of the water reservoir.

This can be done by any suitable means.

However, an in a particularly preferred manner, transportation can be accomplished by launching the caisson on the surface of the water and towing it using at least one motor craft. This is what has been shown in FIG. 8, where two vessels 6 appear.

In another variant, preferred but not shown, transportation occurs using a barge on which the caisson was previously loaded.

There too, it is noted that the “prefabrication” of the caissons 2 in a shipyard is particularly suited because it is provided with suitable lifting means and with docks for launching.

Transportation is therefore accomplished up to the “root” of the reservoir RE.

The following PSH plant consists of immobilizing the caisson in the sea.

This can be done by any known means.

However, it is preferred to use a base embedded in the sea bottom, onto which the caisson is later deposited.

One example of such a base 7 is visible in FIGS. 9 and 11. It is embedded in the sea bottom R, consisting of rocks. It comprises backfill 72, concrete posts 73, a metallic adjusting structure or a reinforced concrete slab 74.

It is clear that the fabrication of this base was carried out prior to the arrival of the caisson.

The installation of the latter is accomplished by ballasting and/or adding weights.

Advantageously and as illustrated in FIG. 9, the distal free end 120 of the tube 1 is stabilized by passing through a stub 121 made of concrete.

The connection of the caisson to the tube can then be carried out.

The plant can then be used as described in the introduction to the present document.

A different embodiment of the distal end 120 is shown in FIG. 10, which is supported directly on a base 75 made of concrete, and ensures its stability.

Finally, a system for protection of the caisson 2 is shown in FIG. 11, which here consists of a jetty 8. It could consist for example of a floating breakwater or a protection system integral with the caisson.

Of course, depending on the power of the plant RE, it is conceivable to use several caissons lashed to one another and positioned in series or in parallel.

Considering that the prefabrication of caissons brings about numerous industrial advantages with respect to an in-situ construction site, particularly in an insular context, that the geographic location of a marine PSH plant offers the possibility of transporting by sea almost any “package,” with no limitation of size or weight (limited only by the stability of the “package”) and that the installation of a hydroelectric plant on land, near the coast, is subjected to very strong environmental constraints (Littoral Law, in France), then the method according to the invention makes it possible to design and prefabricate a hydroelectric plant in the form of a metal caisson in an industrial shipyard, to then transport it by sea to the root of a cliff, install it there and have no more to do than connect it to the water reservoir, presents numerous advantages with respect to the construction of a conventional land-based plant (in a well or in a cavern).

This makes it possible in particular to dispense with the following difficulties:
transportation, as the construction site develops, of different equipment onto a site to which access is necessarily difficult (insular zone, seaside with poor access, etc.);
performance of civil engineering type work (well, cavern) or marine engineering work (water intake) in a difficult environment (particularly if the geological characteristics are unfavorable, as is the case in Guadeloupe);
local industrial network not suitable for heavy work;
verification of the proper operation of the plant and startup delayed and risky;
no general industrialization possible.

The prefabrication of the hydroelectric plant in the form of a metal caisson guarantees obtaining a quality product, control of production delay, optimized cost as well as the possibility of developing an industrial sector.

The implementation of the method according to the invention uses techniques known in themselves and proven, which are re-adapted for this particular case. They call on combined studies of naval architecture, structural calculations and strength of materials, marine engineering, logistics and other specific studies (anti-corrosion, anti-fouling . . . ).

The prefabricated plant fills at the same time the roles of pumping, turbine operation and electricity production—and constitutes as a result the very heart of the marine PSH plant. It can be delivered practically “turnkey” (with the correct operation tested).

Other advantages are cited hereafter:
with the plant resting directly within the lower reservoir (the sea), downstream piping is dispensed with;
the power is adjustable and can evolve depending on the number of caissons that can be added to the others.

More specifically, the plant has the following advantages:
1. A compact plant due to its prefabricated nature;
2. The plant is transportable for installation and for its decommissioning. This is very important, considering the ever more stringent constraints which affect decommissioning operations;
3. “Plug in” type plant (rapid connection to the different land-based networks: fluids, electricity . . . );
4. The metal caisson submerged in seawater is designed for a minimum lifespan of 50 years (without drydocking).

Finally, it can also be considered that the installation itself of the plant at the bottom of a cliff has advantageous aspects:
1. Attaching the caisson to the ground by gravity;
2. Design of a jetty capable of resisting environmental conditions of the cyclonic type in a non-sheltered zone;
3. Completion of all the work within a very short meteorological window (less than 6 months).

1. A method for installing a so-called “marine PSH plant” energy transfer plant, which includes:
a water reservoir located at altitude relative to sea level;
a hydroelectric plant configured to operate as a pump-motor unit to pump water from the sea to said water reservoir, or as a turbine-alternator unit to produce electricity by releasing the water from the reservoir toward the sea via at least one tube connecting said water reservoir to said hydroelectric plant; wherein:
a hydroelectric plant is used which has the shape of at least one caisson of which at least the lower portion is watertight;
said caisson is transported to the “root” of said water reservoir;
said caisson is immobilized in the sea;
and it is connected to said tube.

2. The method according to claim 1, wherein said caisson is immobilized in the sea while it is partially submerged.

3. The method according to claim 1 or 2, characterized by the fact that transportation of said caisson is accomplished by launching it on the surface of the water and towing using at least one motor craft.

4. The method according to claim 1, wherein transportation of said caisson is accomplished by placing it on a barge.

5. The method according to claim 1, wherein the caisson is entirely prefabricated and its proper operation tested.

6. The method according to claim 1, wherein a caisson is used from which at least one pipe protrudes for connection to said tube.

7. The method according to claim 1, wherein, prior to immobilization of said caisson, a base is installed embedded in the sea bottom, onto which said caisson is later brought.

8. The method according to claim 1, wherein a means for protecting the caisson is subsequently placed, such as a jetty, a floating breakwater or a protection system integrated with the caisson.

9. A pumped-storage hydroelectric power plant, so-called a “marine PSH plant,” which includes:
a water reservoir located at altitude relative to sea level; and
a hydroelectric plant configured to operate as a pump-motor unit to pump water from the sea to said water reservoir, or as a turbine-alternator unit to produce electricity by releasing the water from the reservoir to the sea, via at least one tube connecting said water reservoir to the sea,
wherein said hydroelectric plant has the shape of at least one caisson, at least partially watertight, immobilized in the sea at the “root” of said water reservoir.

10. The plant according to claim 9, wherein it comprises several caissons lashed to one another.

11. The plant according to claim 9, wherein the at least one caisson is prefabricated.
